(19) United States
(12) Patent Application Publication
(10) Pub. No.: US 2006/0141928 A1
(43) Pub. Date: Jun. 29, 2006

(54) Radio terminal, method for producing communication packet, and computer-readable recording medium

(75) Inventors: Keisuke Hosokawa, Izumisono-city (JP); Kiyoshi Sakurai, Ikoma-gun (JP)

Correspondence Address: BAKER & MCKENZIE LLP;PATENT DEPARTMENT, 2001 ROSS AVENUE, SUITE 2300, DALLAS, TX, 75201, US

(73) Assignee: Icom Incorporated

(21) Appl. No.: 11/319,967

(22) Filed: Dec. 28, 2005

(30) Foreign Application Priority Data
Dec. 28, 2004 (JP) 2004-380681
Jul. 29, 2005 (JP) 2005-221820

(51) Int. Cl. H04B 17/02

(52) U.S. Cl. 455/9; 455/518

(57) ABSTRACT

In a radio communication system, a radio terminal for communicating with a plurality of radio terminals via repeaters is allowed simplified inputting of identification information of other radio terminals. The radio terminal used in the communication system in which communication is performed between a plurality of radio terminals via repeaters is structured as follows. The radio terminal has a receiving unit and controller for receiving identification information included in a signal sent by other radio terminals, a RAM for storing the signal received by the receiving unit and controller as received data, and a monitor for displaying various data. The controller performs a process for extracting the identification information of the other radio terminals from the received data stored in the RAM. The controller displays the extracted identification information of the other radio terminals on the monitor.

This application is based on Japanese Patent Application No. 2004-380681 filed on Dec. 28, 2004 and Japanese Patent Application No. 2005-221820 filed on Jul. 29, 2005 including the specifications, claims, drawings and summaries. The disclosures of the above Japanese Patent Applications are incorporated herein by reference in their entirety.

### BACKGROUND OF THE INVENTION

1. Field of the Invention

The present invention relates to a radio terminal and a method for producing a communication packet.

2. Description of the Related Art

In some radio communication systems, radio terminals communicate with each other via a plurality of repeaters. In such radio communication systems where radio terminals perform communication with each other via a plurality of repeaters (relay stations), a user who utilizes a radio station has to input identification (ID) information for identifying the repeaters in addition to the ID information identifying the radio station on the user side as the sending side and the ID information identifying the radio station on the communication partner side as the receiving side. Such a bothersome inputting operation has induced a lot of erroneous inputting.

Hence, such a radio communication system has been devised, where a user pre-registers a plurality of communication partner side stations with which he/she can communicate, and selects a pre-registered station from a monitor screen displaying such stations, thereby enabled to perform communication without a bothersome inputting operation (for example, see Unexamined Japanese Patent Application KOKAI Publication No. H10-62190).

### SUMMARY OF THE INVENTION

According to the radio communication system disclosed in Unexamined Japanese Patent Application KOKAI Publication No. H10-62190, users are relieved from the inputting operation by the method of selecting a displayed partner side station. This radio communication system is so arranged that predetermined stations with which communication is possible are displayed in a particular display format different from a format for the other radio stations. However, the users are not allowed to select other stations than the predetermined stations. Furthermore, since this system is not adapted to the communication via repeaters, the users cannot dynamically change the repeaters to which partner side stations belong.

For example, in amateur radio communication, CQ as an appeal for exchange of communication to unspecified general radio communicators, or all communications of other radio stations to which the communication has not been established can be received with own station, and one sometimes wants to have communication with a radio station which has sent CQ, conversation, or topic that has been received by him/her and caught his/her attention. The communication partner side station selecting method disclosed in Unexamined Japanese Patent Application KOKAI Publication No. H10-62190 cannot work in such cases.

Hence, it is an object of the present invention to provide a radio terminal and a method for producing a communication packet, which are capable of smoothing inputting of ID information to be input at the start of communication.

It is another object of the present invention to provide a radio terminal which, when receiving radio communication signal, is capable of easily communicating with a radio station that has sent the radio communication signal.

It is yet another object of the present invention to provide a radio terminal necessitating a less amount of inputting operation.

To achieve the above objects, a radio terminal according to a first aspect of the present invention is a radio terminal used in a communication system in which a plurality of radio terminals communicate with each other via a repeater, the radio terminal comprising:

a monitoring unit which receives a signal exchanged between other radio stations in the communication system and including identification information of the other radio stations, by setting in to a channel at which the signal is sent;

a received data storage unit which stores the signal received by the monitoring unit as received data;

an identification information extraction process unit which performs a process for extracting the identification information of the other radio stations from the received data stored in the received data storage unit;

a display unit which displays various data; and

a communication packet producing process unit which produces a communication packet by which said radio stations sends a signal,

wherein the identification information of the other radio stations extracted by the identification information extraction process unit is displayed on the display unit,

wherein said communication packet producing process unit produces the communication packet by inserting the identification information of said other radio station that is displayed in said display unit.

According to the radio terminal of the present invention, identification information of other radio terminals in the communication system are automatically displayed on the display unit. Accordingly, the displaying of the identification information by the display unit makes it possible to easily acquire the identification information of the other radio stations properly.

This prevents erroneous inputting of the identification information of the other radio stations, and realizes inputting of the identification information that should be input for starting communication with the other radio stations with only a small amount of inputting operation, allowing simplified inputting of the identification information.

The display unit may display, as the identification information of the other radio stations, identification information specifying one of the other radio stations that is on a sending side which sends the signal, identification information specifying another one of the other radio stations that is on a receiving side which receives the signal sent by the other radio station on the sending side, identification information specifying a departure repeater to which the other radio station on the sending side belongs, and identification information specifying a destination repeater to which the other radio station on the receiving side belongs.

According to the present invention, for the other radio station on the sending side and for the other radio station on the receiving side respectively, identification information specifying the radio station itself, and identification information specifying a repeater to which the other radio station belongs are displayed on the display unit. This enables the identification information specifying the other radio stations, and the identification information specifying the repeaters to which the other radio stations belong to be properly acquired.

The display unit may display, as the identification information of the other radio stations, identification information specifying one of the other radio stations that is on a sending side which sends the signal, and identification information specifying a departure repeater to which the other radio station on the sending side belongs.

According to the present invention, identification information specifying the other radio station on the sending side and identification information specifying a repeater to which the other radio station on the sending side belongs are displayed on the display unit. This enables the identification information of the other radio station on the sending side to be acquired properly, and inputting of the identification information of the other radio station on the sending side to be simplified.

When the identification information of the other radio stations are to be stored, the identification information specifying one of the other radio stations that is on the sending side, and the identification information specifying the departure repeater to which the other radio station on the sending side belongs may be stored as an associated pair.

According to the present invention, since the identification information specifying the other radio station on the sending side and the identification information of the repeater to which the other radio station on the sending side belongs are stored as a pair, processes for handling the identification information for performing communication with the other radio station on the sending side can be simplified.

The monitoring unit may be structured to have a function for receiving a signal exchanged between other radio stations that communicate with each other via a repeater to which the radio station belongs, from the repeater.

According to the radio terminal of the present invention, the signal exchanged between the other radio stations is received from the repeater, and the identification information of the other radio stations are acquired from the signal received from the repeater.

The monitoring unit may be structured to have a function for receiving a signal sent from one of other radio stations that communicate with each other via a repeater to which the radio station belongs to that repeater, from the one of the other radio stations.

According to the radio terminal of the present invention, a signal sent from one of the other radio stations to the repeater is directly received, and the identification information of the other radio stations are acquired from this received signal.

The radio terminal may further comprise:

an identification information selecting unit which selects any identification information from the identification information of the other radio stations displayed on the display unit,

wherein the communication packet producing process unit may produce the communication packet by inserting the identification information of the other radio terminal that is selected by the identification information selecting unit.

According to the radio terminal of the present invention, when the identification information selecting unit selects any identification information from the identification information of the other radio stations displayed on the display unit, a communication packet in which the identification information of the selected other radio station is inserted is automatically produced.

Accordingly, when communication with the other radio station selected by the identification information selecting unit is to be started using the present radio terminal, a communication packet based on the identification information of the selected other radio station is automatically produced. This further simplifies inputting of the identification information.

A method for producing a communication packet according to a second aspect of the present invention is a method for producing a communication packet to be sent by a radio station to another radio station in a communication system in which the radio station is used and a plurality of radio stations communicate with each other via a repeater, the method comprising;

a monitoring step of receiving a signal exchanged between other radio stations in the communication system and including identification information of the other radio stations, by setting in to a channel at which the signal is sent;

a received data storing step of storing the signal received at the monitoring step as received data;

an identification information extracting step of extracting the identification information of the other radio stations from the received data stored at the received data storing step; and

a communication packet producing step of producing a communication packet by inserting the identification information of one of the other radio stations, of the identification information of the other radio stations acquired at the identification information extracting step,

whereby a communication packet to be sent to the one of the other radio stations is produced.

According to the present invention, by monitoring a signal exchanged between other radio stations, it is possible to acquire identification information of the other radio stations included in the monitored signal. Then, a communication packet to be sent to one of the other radio stations is produced based on the identification information acquired by monitoring the signal exchanged between these other radio stations. This simplifies the inputting of the identification information of the one radio station, when the radio station is to start communication with the one radio station.

To achieve the above objects, a radio terminal according to a third aspect of the present invention comprises:

a receiving unit which receives a radio signal exchanged between other radio stations and including identification information of the other radio stations;

an identification information extraction unit which extracts the identification information of the other radio stations from the radio signal received by the receiving unit;

an operation unit which is operable by a user and instructs production of a communication packet when being operated; and

a communication packet producing unit which produces the communication packet in response to an operation to the operation unit, by inserting identification information that is the latest among the identification information extracted by the identification information extraction unit.

Preferably, the identification information extraction unit extracts, as the identification of the other radio stations, identification information specifying one of the other radio stations that is to be a companion to which the radio terminal is to send a signal, and identification information specifying a repeater to which the one other radio station belongs, and

the communication packet producing unit produces the communication packet by setting the identification information of the other radio station extracted by the identification information extraction unit as companion identification information, the identification information of the repeater extracted by the identification information extraction unit as destination repeater identification information, identification information of the radio terminal as own station (source station) identification information, and identification information of a repeater to which the radio station belongs as departure repeater identification information.

The operation unit comprises a function for responding to a depression operation, and the communication packet producing unit produces the communication packet in response to a depression operation of a user.

To achieve the above objects, a computer program according to a fourth aspect of the present invention controls a computer to execute: a step of extracting identification information of other radio stations, from a received signal acquired by receiving a radio signal exchanged between the other radio stations and including the identification information of the other radio stations; and a step of producing a communication packet in response to a user's operation made to a predetermined operation unit, by inserting identification information that is the latest among the identification information extracted at the identification information extracting step.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a radio terminal according to the embodiment 1 of the present invention;

FIG. 2 is a diagram showing a communication packet of a signal sent by the radio terminal shown in FIG. 1;

FIG. 3 is a diagram schematically showing the configuration of a communication system in which the radio terminal according to the present invention performs communication;

FIG. 4 is a diagram schematically showing the configuration of a communication system in which the radio terminal according to the present invention performs communication;

FIGS. 5A, 5B, and 5C are diagrams showing communication packets of signals sent by other radio terminals in the communication system shown in FIG. 4;

FIG. 6 is a flowchart showing an identification information acquiring process;

FIG. 7 shows a list of identification information displayed on a monitor of the radio terminal;

FIG. 8 is a block diagram showing the configuration of a radio terminal according to the embodiment 2 of the present invention;

FIG. 9 is a diagram for explaining a process performed by the radio terminal shown in FIG. 8 when receiving communication signals exchanged between other radio terminals;

FIGS. 10A, 10B, and 10C are diagrams for explaining a process performed by the radio terminal shown in FIG. 8 when receiving communication signals exchanged between other radio terminals, where FIG. 10A is a diagram showing an example of a communication packet received, FIG. 10B is a diagram showing an example of callsigns extracted by the radio terminal, and FIG. 10C is a diagram showing an example of a communication packet produced by the radio terminal;

FIG. 11 is a diagram showing an example of a screen displayed on a monitor for a user to decide whether to start communication immediately; and

FIG. 12 is a diagram for explaining another configuration for designating a communication partner.

### DETAILED DESCRIPTION OF THE PREFERRED EMBODIMENTS

### Embodiment 1

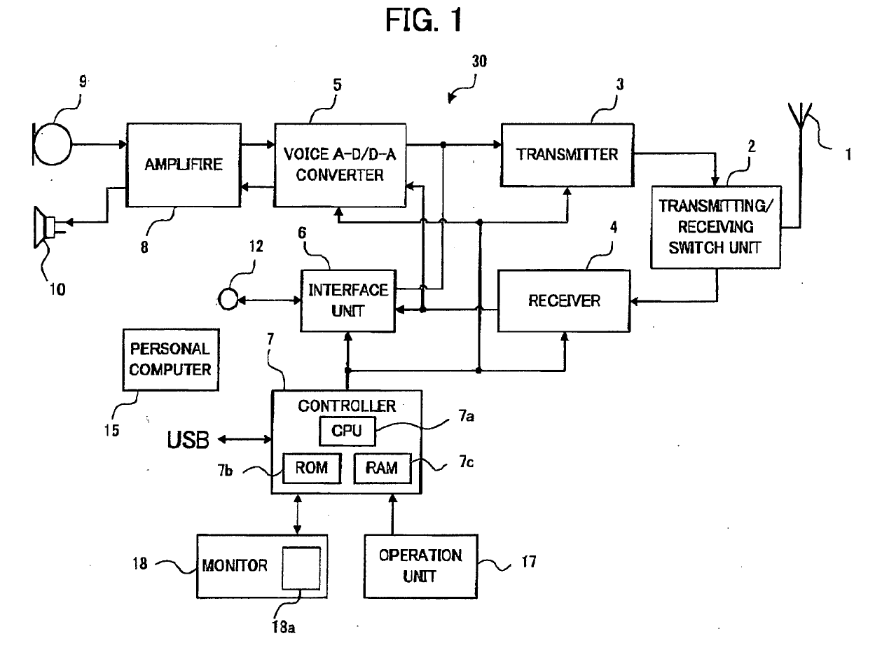

The embodiment 1 of the present invention will now be explained with reference to FIG. 1 to FIG. 7. FIG. 1 is a block diagram of a radio terminal 30 as one embodiment of the present invention. The radio terminal 30 comprises a function for sending a signal and a function for receiving a signal.

In a case where functioning as a sending device in an ordinary communication mode to be described later, the radio terminal 30 sends a voice signal obtained by converting the voice of the user of the radio terminal 30 and a data signal for data communication, to another radio terminal to be the partner of communication.

On the other hand, in a case where functioning as a receiving device in an ordinary communication mode, the radio terminal 30 receives a voice signal sent from another radio terminal to be the partner of communication, and receives a data signal for data communication sent from the other radio terminal. Furthermore, the radio terminal 30 can perform a function of communication monitoring to be described later, by utilizing the receiving function.

As shown in FIG. 1, the radio terminal 30 comprises an antenna 1, a transmitting/receiving switch unit 2, a transmitter 3, a receiver 4, a voice A-D/D-A converting unit 5, an interface unit 6, a controller 7, an operation unit 17, a monitor 18, an amplifier 8, a mike 9, and a speaker 10.

The operation unit 17 is an input means for inputting condition information regarding operation of the radio terminal 30. The operation unit 17 has various operation keys. The user operates the operation keys of the control unit 17 and inputs operation conditions, thereby causing the radio terminal 30 to operate based on the input conditions.

When the user is inputting conditions by operating the operation unit 17, the content of the input operation is displayed on a monitor screen 18a of the monitor 18. Therefore, the user can check the content he/she is to input by operating the operation unit 17 on the monitor screen 18a.

By operating the operation unit 17, the user can set the operation mode in which the radio terminal 30 is controlled to perform a predetermined operation. The radio terminal 30 has an ordinary communication mode and a communication monitoring mode as its operation modes.

The ordinary communication mode is an operation mode in which the radio terminal 30 is controlled to perform an ordinary communication in which it establishes communication with another radio terminal to exchange signals. When the ordinary communication mode is set, the radio terminal 30 functions as a sending device and receiving device for performing ordinary communication.

In the ordinary communication mode, the radio terminal 30 functions as a sending device in a case where it is to send a voice signal, etc. to another radio terminal to be the partner of ordinary communication. On the other hand, the radio terminal 30 functions as a receiving device in a case where it is to receive a voice signal, etc. sent from another radio terminal to be the partner of ordinary communication.

The communication monitoring mode is an operation mode in which the radio terminal 30 is controlled to monitor communication signals exchanged between other radio terminals to which the communication has not been established with the radio terminal 30. In other words, the communication monitoring mode is a mode in which the radio terminal 30 is controlled to receive signals output from other radio terminals having no communication established with the radio terminal 30. The communication monitoring mode is an operation mode based on the receiving function of the radio terminal 30.

When the radio terminal 30 is set to the communication monitoring mode, the user is allowed to input the channel frequency range at which the radio terminal 30 is to monitor communication signals by operating the operation unit 17 while checking the input on the monitor screen 18a.

Note that the radio terminal 30 may be controlled to enter the communication monitoring mode without any particular operation for setting the radio terminal 30 to the communication monitoring mode. That is, the communication monitoring mode may be the default operation mode of the radio terminal 30.

By operating the operation unit 17, the user can input sending side ID information and receiving side ID information. The sending side ID information is identification information of the radio terminal 30 which is to send a signal in an ordinary communication. The sending side ID information includes own station ID information and departure repeater ID information. The own station ID information is identification information for specifying the radio terminal 30 itself. The departure repeater ID information is identification information for specifying the repeater to which the radio terminal 30 belongs.

The receiving side ID information is identification information of another radio terminal to be the partner to which the radio terminal 30 is to send a signal. The receiving side ID information includes companion ID information and destination repeater ID information. The companion ID information is identification information for specifying another radio terminal to which the radio terminal 30 is to send a signal. The destination repeater ID information is identification information for specifying the repeater to which the other radio terminal to which the radio terminal 30 is to send a signal belongs.

The content of the operation to the operation unit 17 is detected by the controller 7. Specifically, the controller 7 detects the types of the operation keys operated and the content of the operation made on the operation keys, and determines the content input by the operation keys. The controller 7 then controls the radio terminal 30 to perform an operation corresponding to the content input form the operation unit 17.

The monitor screen 18a of the monitor 18 displays notifications from the radio terminal 30 to the user about its operational state, messages for the user prompting the user to input information from the operation unit 17, etc. The monitor screen 18a also displays a list of ID information of other radio terminals acquired in the communication monitoring mode.

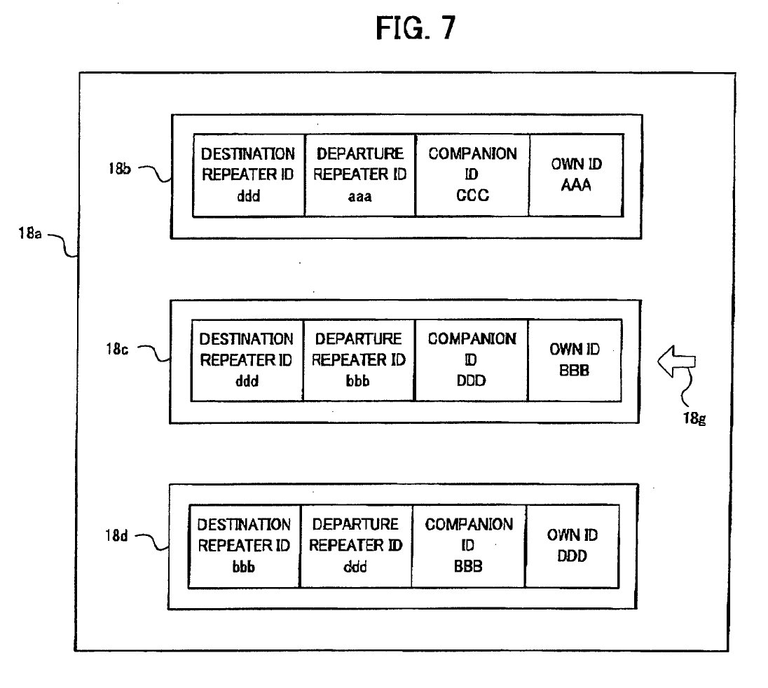

Furthermore, the monitor screen 18a displays an ID information selection cursor, which is not shown in FIG. 1. The user can select ID information to be entered to the radio terminal 30 from the list of ID information of other radio terminals displayed on the monitor screen 18a, by this ID information selection cursor. The ID information selection cursor will be explained later with reference to FIG. 7.

The operation of the radio terminal 30 when functioning as a sending device will now be explained. The voice of the user of the radio terminal 30 is converted into a voice signal by the mike 9, and the voice signal is input to the amplifier 8. The voice signal input to the amplifier 8 is amplified by the amplifier 8 and then output to the voice A-D/D-A converting unit 5.

The voice A-D/D-A converting unit (voice analog-digital/digital-analog converting unit) 5 has an analog-digital converting function for converting a voice signal from/to an analog signal to/from a digital signal.

In a case where the radio terminal 30 functions as a sending device, the voice A-D/D-A converting unit 5 converts an analog voice signal into a digital voice signal. The voice A-D/D-A converting unit 5 converts an analog voice signal input from the amplifier 8 into a digital voice signal and outputs the digitalized voice signal to the transmitter 3.

An external input/output terminal 12 connected to the interface unit 6 has a personal computer for data communication (hereinafter referred to simply as “computer”) 15 connected thereto, so that a data signal for data communication is input to the interface unit 6 from the computer 15 via the external input/output terminal 12. The interface unit 6 outputs the input data signal to the transmitter 3.

The transmitter 3 has a modulation function for modulating the input signal. In case of the present radio terminal 30, the GMSK (Gaussian filtered Minimum Shift Keying) modulation method is adopted as the method employed by the transmitter 3 for modulating a signal. The GMSK modulation method is one digital modulation method, which once filters a binary input signal by a so-called Gaussian filter and then subjects the signal to frequency modulation, thereby aiming for narrowing the frequency band. The transmitter 3 modulates input voice signals and data signals by the GMSK modulation method.

The transmitter 3 outputs the modulated signal to the transmitting/receiving switch unit 2. When the radio terminal 30 functions as a sending device, a circuit for guiding the signal input from the transmitter 3 to the antenna 1 is constructed in the transmitting/receiving switch unit 2. The signal input to the transmitting/receiving switch unit 2 is output to the antenna 1 and sent from the antenna 1 to another radio terminal to be the partner of the radio terminal 30.

The controller 7 controls the operation of the radio terminal 30. The controller 7 comprises a CPU (Central Processing Unit) 7a, a ROM (Read Only Memory) 7b, and a RAM (Random Access Memory) 7c.

The control program for the controller 7 to control the operation of the radio terminal 30 is stored in the ROM 7b. When the radio terminal 30 is to be used as a sending device, the controller 7 controls the radio terminal 30 to function as a sending device. The operation of the interface unit 6 to output data for data communication to the transmitter 3 is performed under the control of the controller 7.

An ID information storage area is developed in the RAM 7c of the controller 7. The ID information of the radio terminal 30 and ID information of other radio terminals are stored in the ID information storage area. When sending side ID information and receiving side ID information are input by operation of the operation unit 17, the input sending side ID information and receiving side ID information are stored in the ID information storage area of the RAM 7c.

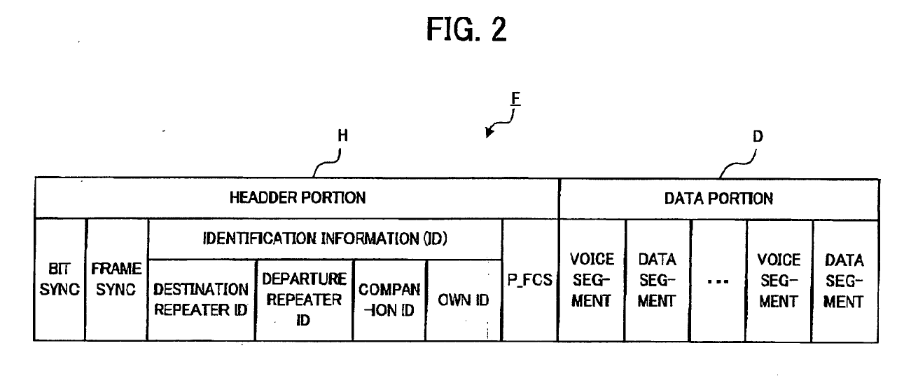

When performing a process for producing a communication packet F (reference to FIG. 2) to be sent by the radio terminal 30, the controller 7 refers to the data of the ID information stored in the ID information storage area. The controller 7 refers to the data of the ID information, and inserts the ID information of the radio terminal 30 and ID information of another radio terminal in a header portion H (reference to FIG. 2) of the communication packet F.

The data of the ID information referred to by the controller 7 for producing a communication packet is stored in a communication packet producing purpose ID information storage area in the ID information storage area. The sending side ID information and receiving side ID information input by operation of the operation unit 17 are stored in the communication packet producing purpose ID information storage area.

For example, a USB (Universal Serial Bus) interface is connected to the controller 7, so that data from an external device connected to the USB interface is input to the controller 7. If a personal computer as an external device is connected to the USB interface, the radio terminal 30 may be controlled by the personal computer.

The communication packet F included in the signal to be sent by the radio terminal 30 will now be explained with reference to FIG. 2. FIG. 2 schematically shows the configuration of the communication packet F from sender's point of view included in the signal to be sent by the radio terminal 30.

As shown in FIG. 2, the communication packet F is made up of a header portion H at the top and a data portion D following the header portion H. The header portion H is a portion used for gaining connection to another radio terminal to be the communication partner in an ordinary communication. The header portion H includes an information signal for establishing communication with another radio terminal.

The bit synchronization included in the header portion H is a signal for controlling a demodulated signal to be synchronized bit-wise. The packet synchronization included in the header portion H is a signal indicating that the signals following this signal are the packet signals carrying the message content to be received.

The ID information (ID) included in the header portion H contains data representing sending side ID information regarding the radio terminal 30 as the own station, and data representing receiving side ID information regarding the other radio terminal as the companion.

The destination repeater ID shown in FIG. 2 is the destination repeater ID information for specifying the repeater to which the other radio terminal to be the companion belongs. The departure repeater ID shown in FIG. 2 is the departure repeater ID information for specifying the repeater to which the radio terminal 30 as the own station belongs.

The companion (receiving station) ID is the companion ID information for specifying the other radio terminal to be the companion. The own station (sending side) ID is the own station ID information for specifying the radio terminal 30 to be the own station. The own station ID is part of the sending side ID information. P_FCS is a packet check sequence for detecting whether the header portion H includes an error.

The data portion D is constituted by repetitive alternate arrangement of voice segments and data segments. A voice segment is a packet in which a voice signal for voice communication is inserted, and in which voice data input from the voice A-D/D-A converting unit 5 is inserted. A data segment is a packet in which a data signal for data communication is inserted, and in which data input from the interface unit 6 is inserted.

Of the communication packet F, the data or signals making up the header portion H are output to the transmitter 3 from the controller 7. The data or signals making up the data portion D are output to the transmitter 3 from the voice A-D/D-A converting unit 5 or from the interface unit 6 under the control of the controller 7.

Next, the operation performed by the radio terminal 30 when functioning as a receiving device will be explained. The radio terminal 30 can be controlled to perform operations as a receiving device in the ordinary communication mode and in the communication monitoring mode by using the receiving function of the radio terminal 30.

In a case where the radio terminal 30 functions as a receiving device and is to receive a signal output from another radio terminal, the signal to be received by the radio terminal 30 constitutes the communication packet F explained with reference to FIG. 2.

The antenna 1 catches a radio signal. The radio signal caught by the antenna 1 is input to the transmitting/receiving switch unit 2. In a case where the radio terminal 30 functions as a receiving device, a circuit for guiding the signal caught by the antenna 1 to the receiver 4 is constructed in the transmitting/receiving switch unit 2.

The receiver 4 has a setting function for selectively receiving a signal of a specific communication channel from the caught signal. The channel of the radio signals to be received is set in the receiver 4. The receiver 4 selects a received signal of a channel for the channel frequency set in the receiver 4, from the signal caught by the antenna 1 and input to the receiver 4 via the transmitting/receiving switch unit 2.

The channel is set in the receiver 4 under the control of the controller 7. The channel for the signals to be received is set in the receiver 4 as described below. In a case where the radio terminal 30 is set to the ordinary communication mode, a channel for receiving a communication signal including a voice signal, etc. that is sent from the radio terminal on the sending side is set.

Further, in a case where the radio terminal 30 is set to the communication monitoring mode, a channel for receiving communication signals exchanged between other radio terminals than the radio terminal 30 is set. Setting of the channel in the receiver 4 in a case where the radio terminal 30 is set to the communication monitoring mode includes setting for a case where a downlink signal from a repeater to a radio terminal is monitored, and setting for a case where an uplink signal from a radio terminal to a repeater is monitored.

In a case where the radio terminal 30 is to receive a downlink signal when monitoring a communication between other radio terminals, i.e., in a case where the radio terminal 30 is to receive a signal sent by the repeater to which the radio terminal 30 belongs, the receiver 4 is set to the channel of the signal sent by that repeater. On the other hand, in a case where the radio terminal 30 is to receive an uplink signal, i.e, in a case where the radio terminal 30 is to receive a signal sent by another radio terminal to a repeater to which that radio terminal belongs, the receiver 4 is set to the channel of the signal sent by that radio terminal to that repeater.

The channel for performing communication monitoring is set in the receiver 4 as follows. Data representing the channel for communication monitoring that is input from the operation unit 17 is input to the RAM 7c of the controller 7. The controller 7 sets data representing the channel stored in the RAM 7c in the receiver 4.

The receiver 4 comprises a demodulating function for demodulating an input received signal. According to the radio terminal 30 of the present embodiment, the receiver 4 demodulates signals by the GMSK method. The data of the header portion H included in the communication packet F of a received signal demodulated by the receiver 4 is input to the controller 7.

In a case where the radio terminal 30 is to talk or exchange data with another radio terminal in the ordinary communication mode, the controller 7 determines whether a received signal from another radio terminal is addressed to the radio terminal 30 based on the information in the header portion H of the received signal. In a case where determining that the received signal is not addressed to the radio terminal 30, the controller 7 discards the data of the header portion H. To the contrary, in a case where determining that the received signal is addressed to the radio terminal 30, the controller 7 controls the received communication packets F to be processed sequentially.

Of the data included in the data portion D of the received signal, voice data included in the voice segment is input to the voice A-D/D-A converting unit 5, and data for data communication included in the data segment is input to the interface unit 6.

The data for data communication input to the interface unit 6 is processed by the interface unit 6 under the control of the controller 7, and output to the computer 15 via the external input/output terminal 12.

The voice A-D/D-A converting unit (voice analog-digital/digital-analog converting unit) 5 comprises an analog-digital converting function for converting a voice signal from/to an analog signal to/from a digital signal. When the radio terminal 30 functions as a receiving device, the voice A-D/D-A converting unit 5 converts a digital voice signal into an analog voice signal. When a digital voice signal is input from the receiver 4, the voice A-D/D-A converting unit 5 converts the input digital voice signal into an analog voice signal under the control of the controller 7.

The voice signal analogued by the voice A-D/D-A converting unit 5 is input to the amplifier 8. The amplifier 8 amplifies the input voice signal and outputs it to the speaker 10. The speaker 10 outputs the talking voice of the user who uses the radio terminal on the other side.

In a case where the radio terminal 30 receives a signal exchanged between other radio terminals in the communication monitoring mode and the received signal is input to the receiver 4, the controller 7 controls the receiver 4 to output the received signal to the RAM 7c of the controller 7.

The controller 7 comprises the CPU 7a, the ROM 7b, and the RAM 7c as described above. A control program for the controller 7 to control the radio terminal 30 to function as a receiving device is stored in the ROM 7b. The ROM 7b stores a control program for controlling the radio terminal 30 to operate as a receiving device in the ordinary communication mode, and a control program for controlling the radio terminal 30 to perform operations for the communication monitoring mode.

The RAM 7c of the controller 7 has an area for storing monitored signals. Data included in a signal sent by another radio terminal that is received in the communication monitoring mode is stored in this monitored signal storage area. When a signal output by another radio terminal is monitored and input to the receiver 4, received data is demodulated from the received signal by the receiver 4 and stored in the monitored signal storage area in the RAM 7c.

When the received data is stored in the monitored signal storage area in the RAM 7c, the controller 7 performs a process for extracting ID information of the other radio terminal included in the received data. The controller 7 stores the extracted ID information in the ID information storage area in the RAM 7c, and performs a process for displaying a list of ID information on the monitor screen 18a of the monitor 18. When storing the ID information of the other radio terminal in the ID information storage area, the controller 7 stores the ID information specifying the other radio terminal and ID information specifying the repeater to which that radio terminal belongs as an associated pair.

When the user selects any ID information from the list of ID information displayed on the monitor screen 18a, the controller 7 performs a process for storing the selected ID information in the communication packet producing-purpose ID information storage area in the RAM 7c.

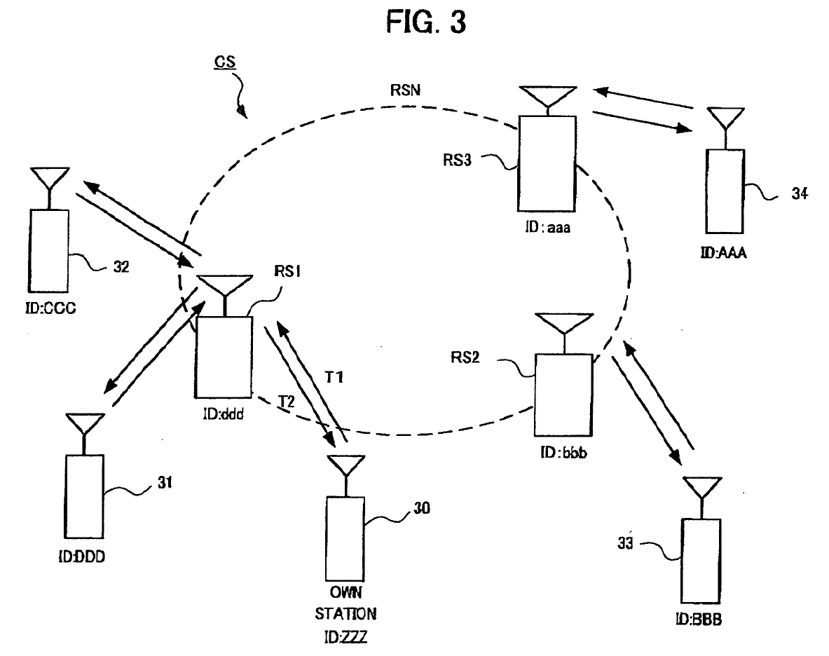

A radio communication system in which the radio terminal 30 described above performs communication with another radio terminal will be explained with reference to FIG. 3. FIG. 3 schematically shows the configuration of a radio communication system CS including the radio station (the radio terminal to be used as the radio station) 30.

The radio communication system CS shown in FIG. 3 includes the radio station 30 and a plurality of radio terminals other than the radio station 30. The radio communication system CS includes a first other radio station 31, a second other radio station 32, a third other radio station 33, and fourth other radio station 34 as the radio terminals other than the radio station 30. The radio communication system CS includes a first repeater RS1, a second repeater RS2, and a third repeater RS3, as repeaters.

The other radio terminals 31 to 34 have the same configuration and functions as the radio terminal 30.

As shown in FIG. 3, the radio station 30, the first other radio station 31, and the second other radio station 32 belong to the first repeater RS1, and communicate with other radio stations than themselves via the first repeater RS1.

As shown in FIG. 3, the third other radio station 33 belongs to the second repeater RS2, and communicates with other radio stations than itself via the second repeater RS2. The fourth other radio station 34 belongs to the third repeater RS3, and communicates with other radio stations than itself via the third repeater RS3.

The first repeater RS1, the second repeater RS2, and the third repeater RS3 constitute a repeater network RSN for exchanging signals among these repeaters.

For example, a signal sent by the radio station 30 addressed to the first other radio station 31 is sent to the first repeater RS1 as shown by T1 in FIG. 3. Then, the signal sent by the radio station 30 is sent to the first other radio station 31 from the first repeater RS1.

A signal sent by the radio station 30 addressed to the third other radio station 33 is sent to the first repeater RS1 as shown by T1 in FIG. 3. Then, the signal sent by the radio station 30 is sent from the first repeater RS1 to the second repeater RS2, and from the second repeater RS2 to the third other radio station 33.

A signal sent by the third other radio station 33 addressed to the radio station 30 is sent to the second repeater RS2. Then, the signal sent by the third other radio station 33 is sent from the second repeater RS2 to the first repeater RS1, and from the first repeater RS1 to the radio station 30 as shown by T2 in FIG. 3.

As shown in FIG. 3, the radio station 30 has an ID (ID information) “ZZZ” assigned thereto. The first other radio station 31 has an ID “DDD” assigned thereto. The second other radio station 32 has an ID “CCC” assigned thereto. The third other radio station 33 has an ID “BBB” assigned thereto. The fourth other radio station 34 has an ID “AAA” assigned thereto.

The first repeater RS1 has an ID “ddd” assigned thereto. The second repeater RS2 has an ID “bbb” assigned thereto. The third repeater RS2 has an ID “aaa” assigned thereto.

In a case where in the radio communication system CS, the radio station 30 is to receive a signal sent by the first repeater RS1 to the radio stations 30, 31, and 32 belonging to the first repeater RS1, the signal to be received by the radio station 30 is a downlink signal. On the other hand, in a case where the radio station 30 is to directly receive a signal sent by the first other radio station 31 to the first repeater RS1, the signal to be received by the radio station 30 is an uplink signal.

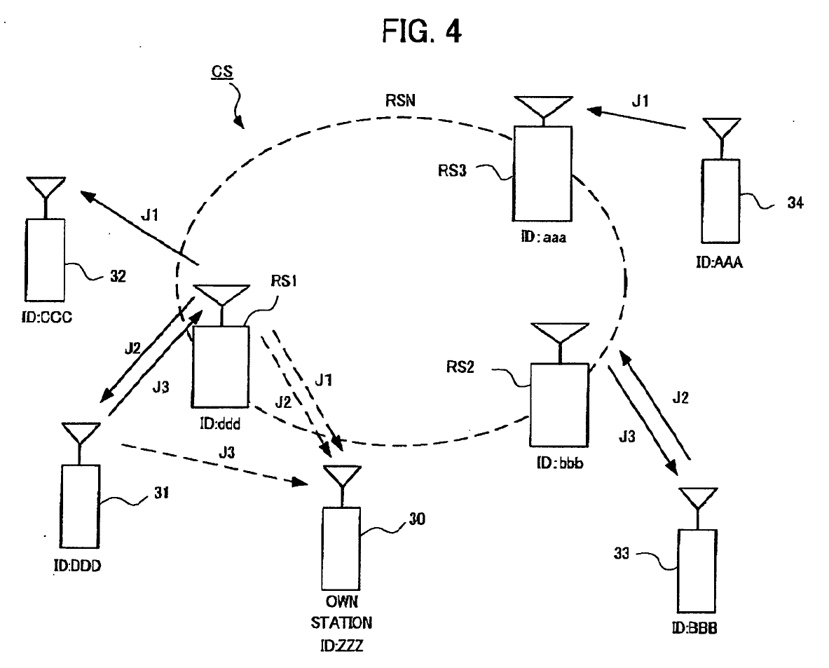

Next, the operation of the above-described radio station 30 for monitoring a signal exchanged between other radio stations in the radio communication system CS will be explained with reference to FIG. 4 to FIG. 7.

FIG. 4 is a diagram showing the configuration of the radio communication system CS. In FIG. 4, signals sent by other radio stations are shown. As shown in FIG. 4, the communication system CS comprises the radio station 30, a first other radio station 31, a second other radio station 32, a third other radio station 33, a fourth other radio station 34, a first repeater RS1, a second repeater RS2, and a third repeater RS3.

The radio station 30, the first other radio station 31, and the second other radio station 32 belong to the first repeater RS1. The third other radio station 33 belongs to the second repeater RS2. The fourth other radio station 34 belongs to the third repeater RS3.

As shown in FIG. 4, the fourth other radio station 34 sends a signal J1 to the second other radio station 32. The signal J1 which the fourth other radio station 34 sends to the second other radio station 32 is relayed by the third repeater RS3 and the first repeater RS1 to be sent to the second other radio station 32.

The third other radio station 33 sends a signal J2 to the first other radio station 31. The signal J2 sent by the third other radio station 33 to the first other radio station 31 is relayed by the second repeater RS2 and the first repeater RS1 to be sent to the first other radio station 31.

The first other radio station 31 sends a signal J3 to the third other radio station 33. The signal J3 sent by the first other radio station 31 to the third other radio station 33 is relayed by the first repeater RS1 and the second repeater RS2 to be sent to the third radio station 33.

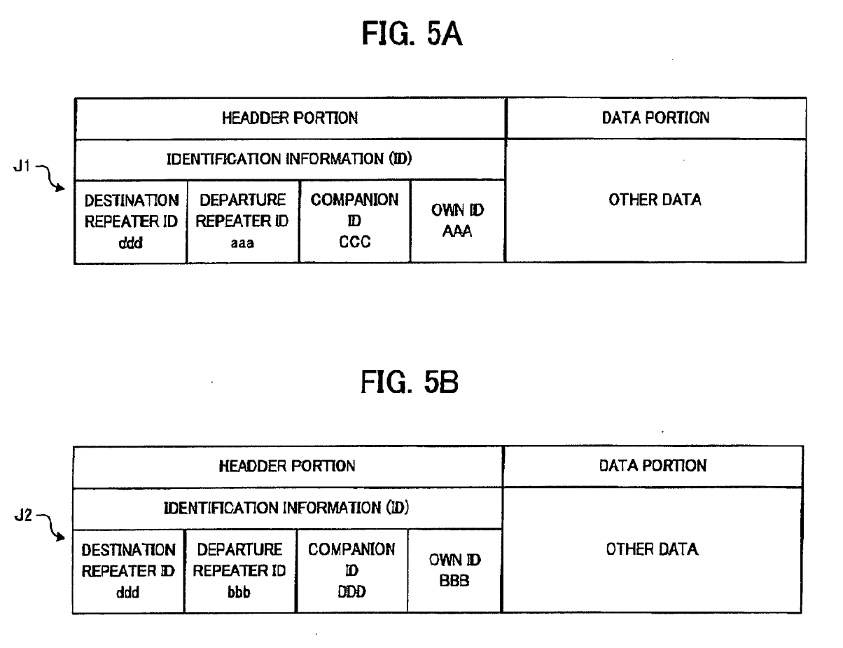

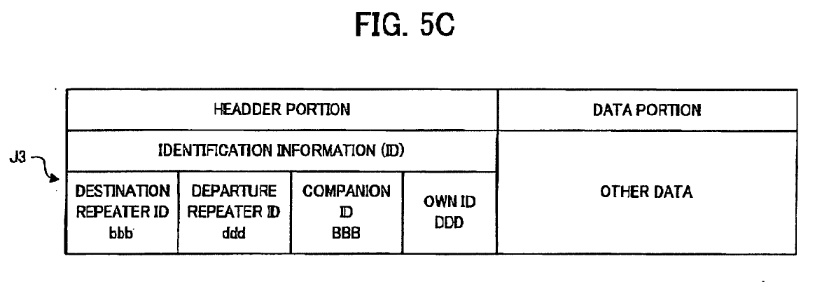

FIG. 5 are diagrams showing the communication packets included in the signals sent by the other radio stations shown in FIG. 4. FIG. 5A shows the communication packet of the signal J1, FIG. 5B shows the communication packet of the signal J2, and FIG. 5C shows the communication packet of the signal J3.

As shown in FIG. 5, each of the signals J1, J2, and J3 comprises a header portion and a data portion. The header portion includes an identification (ID) information portion. FIG. 5 show only ID information as data inserted in the header portion, and omit other kinds of data to be inserted in the header portion.

As shown in FIG. 5A, inserted in the ID information portion of the communication packet of the signal J1 are ID information “AAA” specifying the fourth other radio station 34 as the own station, ID information “aaa” specifying the third repeater RS3 as the departure repeater to which the radio station 34 belongs, ID information “CCC” specifying the second other radio station 32 as the companion, and ID information “ddd” specifying the first repeater RS1 as the destination repeater to which the radio station 32 belongs.

As shown in FIG. 5B, inserted in the ID information portion of the communication packet of the signal J2 are ID information “BBB” specifying the third other radio station 33 as the own station, ID information “bbb” specifying the second repeater RS2 as the departure repeater to which the radio station 33 belongs, ID information “DDD” specifying the first other radio station 31 as the companion, and ID information “ddd” specifying the first repeater RS1 as the destination repeater to which the radio station 31 belongs.

As shown in FIG. 5C, inserted in the ID information portion of the communication packet of the signal J3 are ID information “DDD” specifying the first other radio station 31 as the own station, ID information “ddd” specifying the first repeater RS1 as the departure repeater to which the radio station 31 belongs, ID information “BBB” specifying the third other radio station 33 as the companion, and ID information “bbb” specifying the second repeater RS2 as the destination repeater to which the radio station 33 belongs.

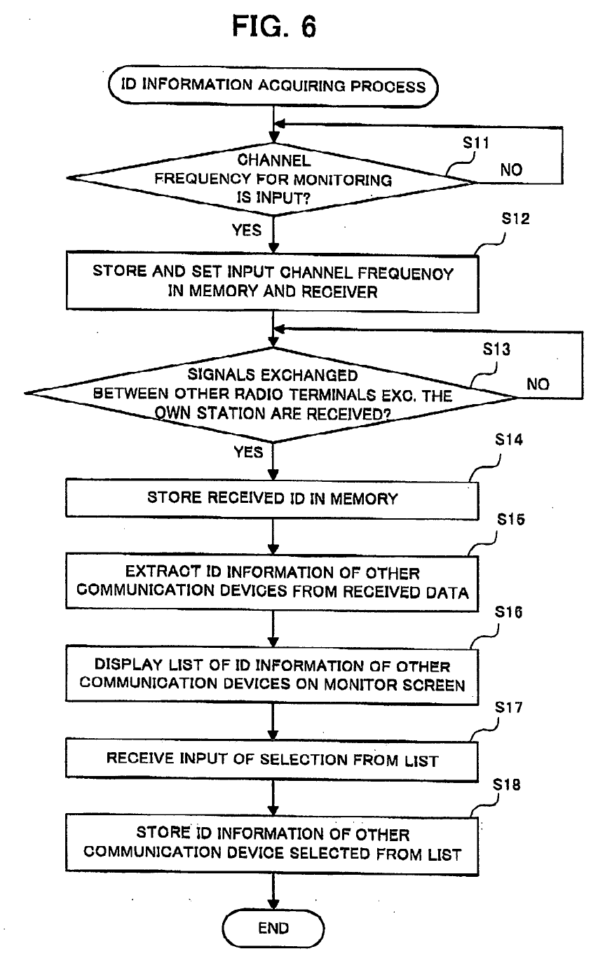

The radio station 30 is operated in this state where the signals J1, J2, and J3 are being sent in the radio communication system SC. The radio station 30 is operated in the communication monitoring mode by making a predetermined operation to the operation unit 17. This triggers an ID information acquiring process shown in the flowchart of FIG. 6 to be started.

When the controller 7 detects that a channel frequency for performing communication monitoring is input by an operation of the user (step S11, YES), the controller 7 stores the input channel frequency in the memory (RAM 7c) and sets it in the receiver 4 (step S12).

When detecting that the receiver 4 receives the signals J1, J2, and J3 sent by the other radio stations 31, 33, and 34 and exchanged between the other radio stations except the own station (step S13, YES), the controller 7 stores the received data in the memory (the monitored signal storage area in the RAM 7c) (step S14).

Next, the controller 7 performs a process for extracting the ID information of the other radio stations from the received data stored in the memory at step S14 (step S15). Then, the controller 7 displays a list of ID information of the other radio stations 31 to 34 acquired in the extraction process at step S5 on the monitor screen 18a (step S16). The controller 7 also stores the extracted ID information of the other radio stations in the ID information storage area in the RAM 7c.

FIG. 7 shows the list of ID information of the other radio stations 31 to 34, that is displayed on the monitor screen 18a at step S16. The ID information inserted in the signal J1 is displayed on a first display area 18b of the monitor screen 18a. The ID information inserted in the signal J2 is displayed on a second display area 18c of the monitor screen 18a. The ID information inserted in the signal J3 is displayed on a third display area 18d of the monitor screen 18a.

FIG. 7 shows a state where an ID information selection cursor 18g is displayed on the monitor screen 18a. In the example of FIG. 7, the ID information selection cursor 18g points to the second display area 18c, thus the ID information displayed on the second display area 18c is selected.

The controller 7 performs a process for receiving an input for selecting the ID information displayed on the second display area 18c, that is entered by operating, for example, a cursor moving key and an enter key of the operation unit 17 for moving the ID information selection cursor 18g (step S17).

Then, the controller 7 stores the ID information of the other radio stations 31 and 33 displayed on the second display area 18c selected from the list in the memory (the communication packet producing-purpose ID information storage area) (step S18). Then, the controller 7 terminates the ID information acquiring process.

When the ID information of the other radio station 33 is stored at step S18, the ID information “BBB” of the other radio station 33 and the ID information “bbb” of the second repeater RS2 to which the other radio station 33 belongs may be stored in association. When the ID information of the other radio station 31 is stored at step S18, the ID information “DDD” of the other radio station 31 and the ID information “ddd” of the first repeater RS1 to which the other radio station 31 belongs may be stored in association.

According to the above-described ID information acquiring process, in accordance with the user's selection, the ID information of the third other radio station 33 and first other radio station 31 are stored in the ID information storage area of the RAM 7c, and are automatically set in the radio station 30. This enables the radio station 30 to refer to the data of the ID information of the other radio station 33 or 31, when producing a communication packet to be sent to the other radio station 33 or 31.

This frees the user from inputting the ID information of the other radio station 33 or 31 when starting communication with the other radio station 33 or 31 using the radio station 30, thereby simplifying the user's inputting operation with a bothersome operation of inputting ID information not required.

In the above-described ID information acquiring process, when the ID information of the other radio stations acquired by communication monitoring are to be displayed on the monitor screen 18a, the ID information of the own station and the ID information of the companion in the communication packet assembled by the other radio stations are both displayed as shown in FIG. 7. When the ID information of the other radio stations acquired by communication monitoring are to be displayed on the monitor screen 18a, only the ID information of the own station may be displayed and display of the ID information of the companion may be omitted.

If at least the ID information of the own station is displayed on the monitor screen 18a, the data of the ID information of the other radio station as the own station can be referred to when producing a communication packet addressed to this radio station. Thus, the user of the radio station 30 can skip the operation of inputting the ID information of the own station. This enables the user to forgo the bothersome operation and simplifies the user's inputting.

In the foregoing explanation, the signal modulation method employed for exchanging signals between the radio terminals is the GMSK modulation method. For carrying out the present invention, other modulation methods may be employed. The QPSK (Quadrature Phase Shift Keying) modulation method or other types of modulation methods may be employed as the signal modulation method for carrying out the present invention.

Furthermore, in the foregoing explanation, the case where data taken into the radio terminal 30 from the computer 15 is sent in a data segment is exemplified. For carrying out the present invention, the radio terminal may take in digital data output from other devices than a personal computer, and send this digital data by inserting it in a data segment. For example, the radio terminal according to the present invention may take in GPS (Global Positioning System) data, and send the data by inserting it in a data segment.

### Embodiment 2

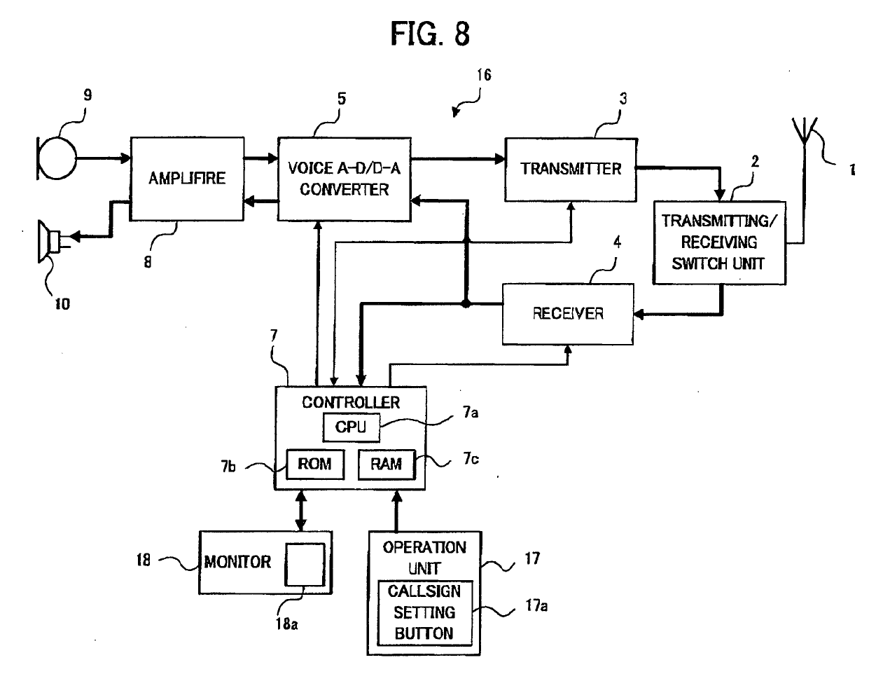

Next, an embodiment will be explained where a communication packet F in which the latest associated pair of ID information that are stored in the storage area are set as the ID information of the companion will be produced. FIG. 8 is a block diagram showing the configuration of a radio terminal 16 as the radio terminal in the embodiment 2. In the embodiment 2, an amateur radio system is assumed as a radio communication system 100. In case of amateur radio, the ID information of each radio station is named callsign.

As shown in FIG. 8, the configuration of the radio terminal 16 is almost the same as that of the radio terminal 30 of the embodiment 1. However, the operation unit 17 comprises a callsign setting button 17a for acquiring the sending side ID information (a departure repeater callsign and a own radio station callsign) of the communication signal now being received, and producing a header portion H of a communication packet F. In FIG. 8, the interface unit 6, the external input/output terminal 12, and the computer 15 are not illustrated.

The content of the operation made to the operation unit 17 is detected by the controller 7. That is, the controller 7 detects the types of the operation keys operated, and the content of the operation made to the operation keys. The controller 7 then determines the content input by the operation keys and controls the radio terminal 16 to operate in accordance with the input content.

Particularly, when the controller 7 detects that the callsign setting button 17a is operated, it extracts the callsign of a departure repeater (repeater ID) and the callsign of a source radio station (own station ID) from the communication packet F now being received, and performs a process for producing and sending a communication packet F in order to start communication with that radio station 15 which is to be in turn the companion radio station.

According to the embodiment 2, the controller 7 stores received signals supplied thereto from the receiver 4 in the RAM 7c sequentially, irrespective of whether the signals are addressed to the radio terminal 16 or not. When the received signals are stored in the RAM 7c, the controller 7 extracts the departure repeater callsign (departure repeater ID) and the own radio station callsign (own station ID) from the callsigns included in the header portion H of each received signal. The controller 7 stores the extracted callsigns in a callsign storage area of the RAM 7c.

When the user operates the callsign setting button 17a, the controller 7 produces a communication packet F in which the latest pair of callsigns that are stored in the callsign storage area of the RAM 7c are set as the callsigns of the companion. The user can easily start communication, using this automatically produced communication packet F.

The operation of the radio terminal 16 having the above-described configuration for producing a communication packet will be more specifically explained.

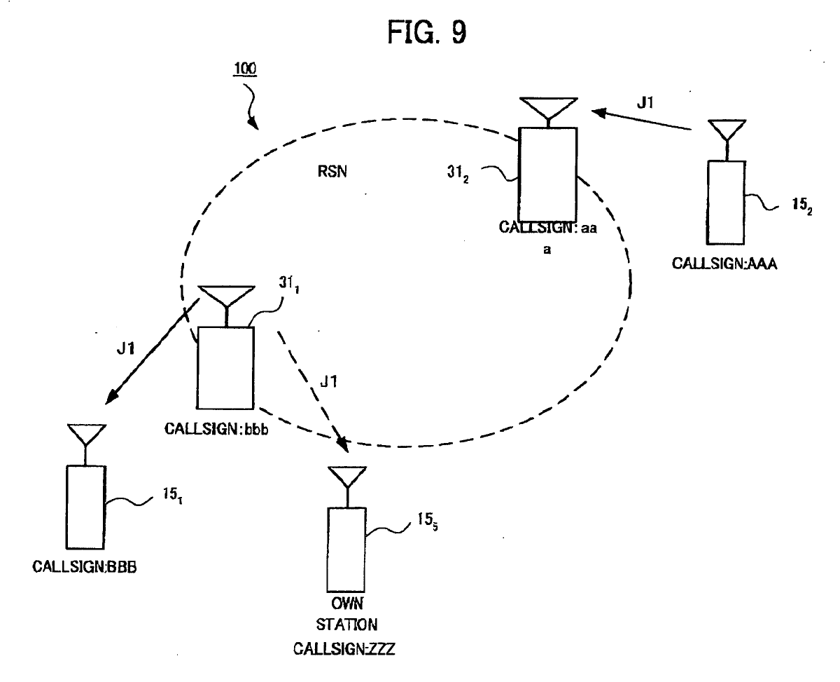

FIG. 9 is an exemplary diagram for explaining the operation according to the embodiment 2, and shows the configuration of the radio communication system 100. In FIG. 9, signals sent by other radio stations are shown. As shown in FIG. 9, the radio communication system 100 comprises a radio station (radio terminal to be used as radio station) 15₅, a first other radio station 15₂, a second other radio station 15₁, a first terminal repeater 31₁, and a second terminal repeater 31₂. Each of the radio station 15₅, the first other radio station 15₂, and the second other radio station 15₁ comprises the radio terminal 16 shown in FIG. 8.

The radio station 15₅ and the second other radio station 15₁ belong to the first terminal repeater 31₁. The first other radio station 15₂ belongs to the second terminal repeater 31₂.

As shown in FIG. 9, the first other radio station 15₂ sends a signal J1 to the second other radio station 15₁. The signal J1 sent by the first other radio station 15₂ to the second other radio station 15₁ is relayed by the second terminal repeater 31₂ and the first terminal repeater 31₁ and sent to the second other radio station 15₁.

As shown in FIG. 9, a callsign “ZZZ” is assigned to the radio station 15₅, a callsign “BBB” is assigned to the second other radio station 15₁, and a callsignal “AAA” is assigned to the first other radio station 15₂. A callsign “bbb” is assigned to the first terminal repeater 31₁, and a callsign “aaa” is assigned to the second terminal repeater 31₂. These three radio stations 15₁, 15₂, and 15₅, and two terminal repeaters 31₁ and 31₂ are located within one zone.

As shown in FIG. 9, assume that the first other radio station 15₂ sends a signal J1 to the second other radio station 15₁. The signal J1 is relayed by the second terminal repeater 31₂, sent from the first terminal repeater 31₁, and received by the second other radio station 15₁. The radio station 15₅ whose reception channel is set to one for downlink signals also receives the signal J1.

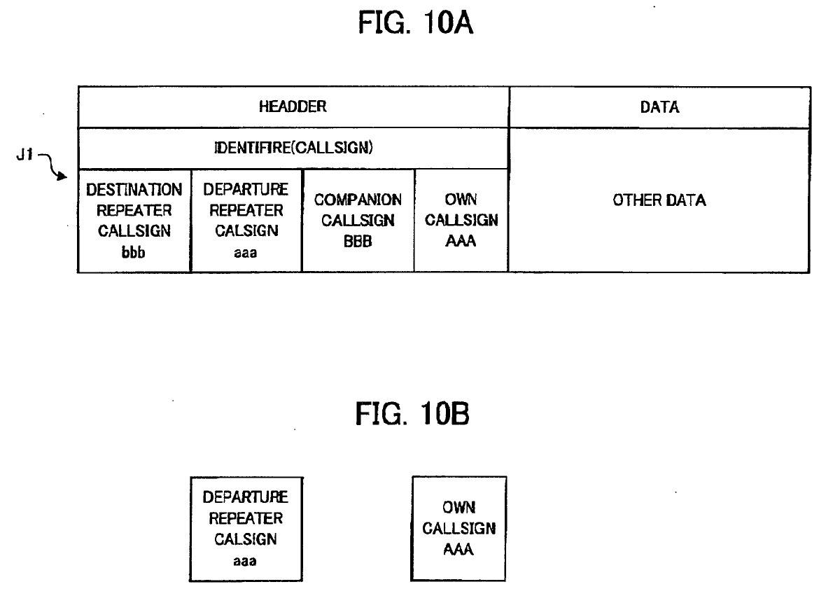

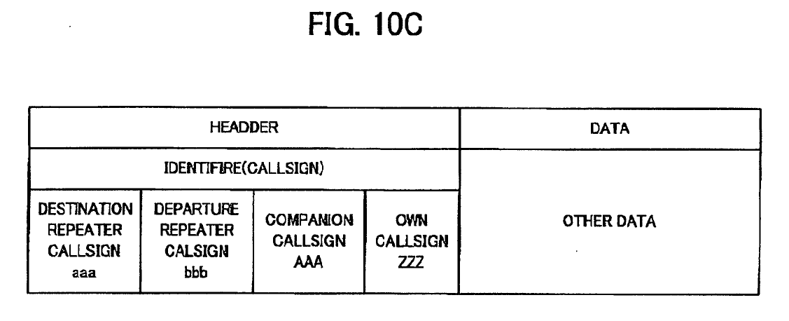

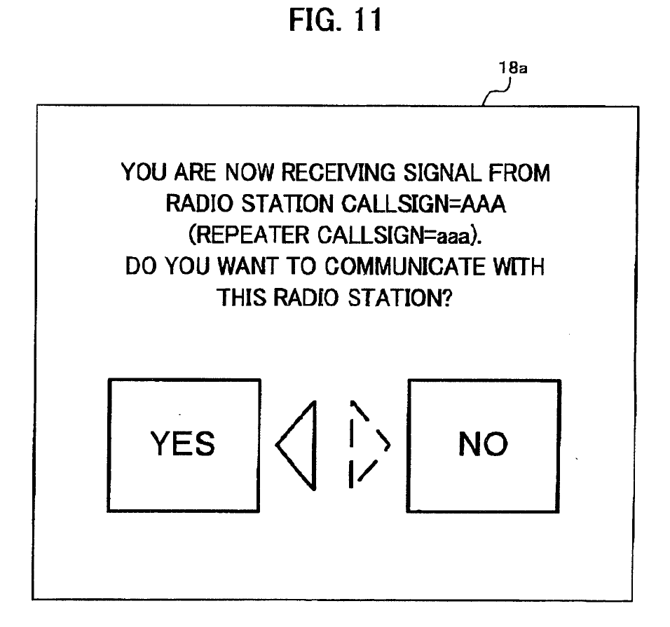

FIG. 10A is a diagram showing a specific example of a communication packet received. As shown in FIG. 10A, inserted in the header portion of the communication packet of the signal J1 are the destination repeater callsign “bbb”, the departure repeater callsign “aaa”, the companion radio station callsign “BBB”, and the own radio station callsign “AAA”.

The radio signal launched from the first terminal repeater 31₁ is received also by the radio station 15₅.

While a downlink channel frequency is set in the receiver 4 as its reception channel by an operation of the user, the communication packet F of the signal received is supplied to the controller 7 of the radio station 15₅.

When detecting that the receiver 4 receives a certain signal (data), the controller 7 stores the received data in the callsign storage area of the RAM 7c.

FIG. 10B is a diagram showing an example of callsigns extracted by the radio station. The controller 7 extracts the destination repeater callsign “aaa” and source radio station callsign “AAA” shown in FIG. 10B, from the header portion H of the received data as stored.

Meanwhile, voice data included in the received signal is output from the speaker 10 in the form of voice, thus the user of the radio terminal 16 in FIG. 8 can listen to the message though the message is not addressed to the own radio station on his/her side. For example, CQ or the like, which is a call for attention for unspecific radio stations from one of the other radio stations, is also output in the form of voice. In a case where the user is to answer to the CQ, or wants to communicate with the source radio station (own station (caller)) that has sent the signal received (now being received), the user depresses (touches, clicks) the callsign setting button 17a.

FIG. 10C is a diagram showing an example of a communication packet produced by the radio station. When the callsign setting button 17a is depressed, the controller 17 produces a communication packet F by using the extracted callsigns. That is, as shown in FIG. 10C, the controller 7 produces the header portion H by setting the extracted departure repeater callsign “aaa” as the destination repeater callsign, the extracted own radio station callsign “AAA” as the companion radio station callsign, the callsign “bbb” of the first terminal repeater 31₁ to which the radio station 15₅ belongs as the departure repeater callsign, and the callsign “ZZZ” of the radio station 15₅ as the own radio station callsign.

Next, when the user operates the operation unit 17 to activate the sending function, the controller 7 sends out the communication packet F including the header portion H at an appropriate timing. Afterwards, the controller 7 performs an ordinary sending operation where voice fames and data packets (synchronization data) are repeated.

As explained above, according to the radio terminal 16 in FIG. 8 of the present embodiment, in a case where the user wants to quickly respond to the CQ as a call for attention from another radio station addressed to unspecified radio stations or in a case where the user, who has listened to voice communication exchanged between other radio stations, wants to communicate with one of the radio stations, the user only needs to do quite a simple operation of depressing the callsign setting button 17a with no need of inputting or selecting callsigns, whereby the communication partner can be easily specified and the user can quickly start communication.

The timing at which the user depresses the callsign setting button 17a is arbitrary. For example, the communication packet F may be produced based on the call sings that have been extracted most lately at the time the callsign setting button 17a is depressed. In this case, for example, a time stamp may be applied to each callsign when the callsign is extracted, so that the chronology of the callsigns may be determined based on the time stamps. Alternatively, some users might prefer it to be such that only in a case where any signal happens to be received when the user depresses the callsign setting button 17a, the communication packet F will be produced based on the callsigns included in the header portion of the signal.

Yet alternatively, only in a case where received is a voice communication, the callsigns in the voice signal may be extracted and the header portion H of the communication packet F may be produced. In this case, when it is detected that the callsign setting button 17a is depressed, it may be determined whether the communication signal is a data communication or a voice communication, and the packet to be sent may be produced in a case where determined that it is a voice communication.

According to the embodiment 2, the extraction of callsigns takes place before the callsign setting button 17a is depressed. However, it may take place after the depression of the callsign setting button 17a is detected.

According to the embodiment 2, the signal to be received is only that that is from a downlink channel. However, it may be only that that is from an uplink channel or may be both.

Furthermore, at the time the header portion H is extracted, for example, a message such as “Do you want to communicate with the radio station you are now receiving (receiving and reproducing) messages from?” may be displayed on the monitor 18 together with operation buttons (including icons, etc.), so that the communication packet F may be produced depending on the user's response (an operation by a button, icon, mouse, or pad) to the message.

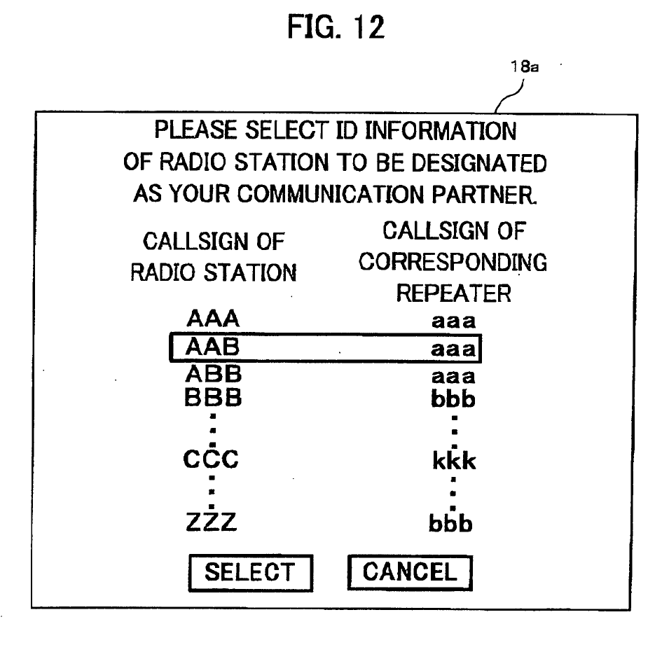

To further simplify the callsign setting, in addition to the above-described callsign automatic setting function, the callsigns (pairs of callsigns) extracted by the controller 7 may be accumulated in the RAM 7c in a database form and displayed on the monitor screen 18a as shown in FIG. 12, so that the user can select callsigns from the monitor screen 18a by operating the operation unit 17. Furthermore, the accumulated database may be search-enabled, so that the controller 7 may set the header portion H of the communication packet F in accordance with the searching and selecting operation from the operation unit 17.

The embodiment 2 features producing a communication packet (particularly, the header portion H) with a simple operation. Therefore, the configuration of the operation instructing means as the callsign setting button 17a is arbitrary whether it is hardware, software, a button, an icon, a mouse, a pad, a switch or a key, etc., as long as the instruction can be entered by a simple one touch or one action, or something like that.

The amateur radio communication has the established characteristic of allowing the messages communicated between other amateur radio stations to be received and reproduced, and the present invention is particularly effective for this system. However, the present invention is not limited to the amateur radio communication. The present invention may be applied to various types of communication methods as long as interaction between other devices is received and the header portion can be produced by extracting ID information equivalent to callsigns from the received signal. Further, according to the embodiment 2, the sending side callsigns (ID information) in the received communication packet are extracted and set as the companion. However, the receiving side callsigns (ID information) in the received communication packet may be extracted and set as the companion to produce the communication packet.

The controller 7, the transmitter 3, the receiver 4, etc. shown in FIG. 8 may be configured by using a microprocessor, for example by using a DSP (Digital Signal Processor).

In the above-described explanation, the signal modulation method employed for exchanging radio signals between the radio stations is the GMSK modulation method. For carrying out the present invention, other modulation methods may be employed. The QPSK modulation method or other types of modulation methods may be employed as the signal modulation method for carrying out the present invention.

### INDUSTRIAL APPLICABILITY

According to the present invention, within a communication system, a radio terminal acquires the ID information of the other radio terminal that should be input in order to start communication with that radio terminal, by receiving a signal sent by that radio terminal. This makes it possible to easily acquire the ID information of the other radio terminal properly. The operation of inputting the ID information can be simplified because the ID information of the other radio terminal acquired from the received information is selected and used for sending. Besides, a quick communication becomes available by producing and sending a communication packet by using the acquired ID information. Furthermore, in a case where communication with a radio station is desired while signals from that radio station are being received, the communication can be started by a simple operation.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A radio terminal used in a communication system in which a plurality of radio terminals communicate with each other via a repeater, said radio terminal comprising:
a monitoring unit which receives a signal exchanged between other radio stations in said communication system and including identification information of said other radio stations, by setting in to a channel at which the signal is sent;
a received data storage unit which stores the signal received by said monitoring unit as received data;
an identification information extraction process unit which performs a process for extracting the identification information of said other radio stations from the received data stored in said received data storage unit;
a display unit which displays various data; and
a communication packet producing process unit which produces a communication packet by which said radio stations sends a signal,
wherein the identification information of said other radio stations extracted by said identification information extraction process unit is displayed on said display unit,
wherein said communication packet producing process unit produces the communication packet by inserting the identification information of said other radio station that is displayed in said display unit.

2. The radio terminal according to claim 1, wherein said display unit displays, as the identification information of said other radio stations, identification information specifying one of said other radio stations that is on a sending side which sends the signal, identification information specifying another one of said other radio stations that is on a receiving side which receives the signal sent by said other radio station on the sending side, identification information specifying a departure repeater to which said other radio station on the sending side belongs, and identification information specifying a destination repeater to which said other radio station on the receiving side belongs.

3. The radio terminal according to claim 1, wherein said display unit displays, as the identification information of said other radio stations, identification information specifying one of said other radio stations that is on a sending side which sends the signal, and identification information specifying a departure repeater to which said other radio station on the sending side belongs.

4. The radio terminal according to claim 2, wherein when the identification information of said other radio stations are to be stored, the identification information specifying one of said other radio stations that is on the sending side, and the identification information specifying said departure repeater to which said other radio station on the sending side belongs are stored as an associated pair.

5. The radio terminal according to claim 3, wherein when the identification information of said other radio stations are to be stored, the identification information specifying one of said other radio stations that is on the sending side, and the identification information specifying said departure repeater to which said other radio station on the sending side belongs are stored as an associated pair.

6. The radio terminal according to claim 1, wherein said monitoring unit receives a signal exchanged between other radio stations that communicate with each other via a repeater to which said radio terminal belongs, from said repeater.

7. The radio terminal according to claim 1, wherein said monitoring unit receives a signal exchanged between other radio stations that communicate with each other via a repeater to which said radio terminal belongs, from said other radio stations.

8. The radio terminal according to claim 1, further comprising:
an identification information selecting unit which selects any identification information from the identification information of said other radio stations displayed on said display unit.

9. A method for producing a communication packet for producing a communication packet to be sent by a radio station to another radio station in a communication system in which said radio station is used and a plurality of radio stations communicate with each other via a repeater, said method comprising;
a monitoring step of receiving a signal exchanged between other radio stations in said communication system and including identification information of said other radio stations, by setting in to a channel at which the signal is sent;
a received data storing step of storing the signal received at said monitoring step as received data;
an identification information extracting step of extracting the identification information of said other radio stations from the received data stored at said received data storing step; and
a communication packet producing step of producing a communication packet by inserting the identification information of one of said other radio stations, of the identification information of said other radio stations acquired at said identification information extracting step,
whereby a communication packet to be sent to said one of said other radio stations is produced.

10. A radio terminal, comprising:
a receiving unit which receives a radio signal exchanged between other radio stations and including identification information of said other radio stations;
an identification information extraction unit which extracts the identification information of said other radio stations from the radio signal received by said receiving unit;
an operation unit which is operable by a user and instructs production of a communication packet when being operated; and
a communication packet producing unit which produces the communication packet in response to an operation to said operation unit, by inserting identification information that is the latest among the identification information extracted by said identification information extraction unit.

11. The radio terminal according to claim 10, wherein:
said identification information extraction unit extracts, as the identification of said other radio stations, identification information specifying one of said other radio stations that is to be a companion to which said radio station is to send a signal, and identification information specifying a repeater to which said one other radio station belongs; and
said communication packet producing unit produces the communication packet by setting the identification information of said other radio station extracted by said identification information extraction unit as companion identification information, the identification information of said repeater extracted by said identification information extraction unit as destination repeater identification information, identification information of said radio terminal as own station identification information, and identification information of a repeater to which said radio terminal belongs as departure repeater identification information.

12. The radio terminal according to claim 10, wherein:
said operation unit comprises a function for responding to a depression operation; and
said communication packet producing unit produces the communication packet in response to a depression operation of a user.

13. The radio terminal according to claim 11, wherein:
said operation unit comprises a function for responding to a depression operation; and
said communication packet producing unit produces the communication packet in response to a depression operation of a user.

14. A computer-readable recording medium storing a computer program for controlling a computer to execute:
a step of extracting identification information of other radio stations, from a received signal acquired by receiving a radio signal exchanged between said other radio stations and including the identification information of said other radio stations; and
a step of producing a communication packet in response to a user's operation made to a predetermined operation unit, by inserting identification information that is the latest among the extracted identification information.
